(19) United States
(12) Patent Application Publication
(10) Pub. No.: US 2009/0177359 A1
(43) Pub. Date: Jul. 9, 2009

(54) Collision damage reduction apparatus

(76) Inventors: Toru Ihara, Kawasaki (JP); Keiichi Yamamoto, Kawasaki (JP)

Correspondence Address: JACOBSON HOLMAN PLLC, 400 SEVENTH STREET N.W., SUITE 600, WASHINGTON, DC, 20004, US

(21) Appl. No.: 12/314,741

(22) Filed: Dec. 16, 2008

(30) Foreign Application Priority Data
Dec. 25, 2007 (JP) 2007-332425

(51) Int. Cl. G06F 7/00

(52) U.S. Cl. 701/45

(57) ABSTRACT

A collision damage reducing apparatus for lessening vehicle collision damage, includes: designated obstacle detecting means detecting an object having a collision possibility to be a obstacle; calculating means obtaining a continuous detecting period, for which the object is detected as the obstacle; monitoring target acknowledging means, according to the continuous detecting period, deciding whether or not the obstacle is regarded as a monitoring target, and deciding whether or not the obstacle is regarded as an activation cause; reliability determining means judging a collision possibility if the continuous detecting period is longer than a threshold value, and defining a reliability level coefficient indicating obstacle's reliability if a result of the judging of the collision possibility is positive; attentiveness determining means defining attentiveness coefficient decreased according to attentiveness deterioration; and detecting period threshold value adjusting means decreasing the threshold value according to decrease in the attentiveness coefficient.

### BACKGROUND OF THE INVENTION

(1) Field of the Invention

The present invention relates to a collision damage reducing apparatus associated with a collision damage reducing apparatus.

(2) Description of Related Art

There has been conventionally developed an apparatus (a so-called collision damage reduction braking apparatus) to brake a moving vehicle before the vehicle collides with an obstacle (e.g., a moving or stopping preceding vehicle, or a utility pole) ahead of the vehicle.

There has also been developed an apparatus (a so-called collision warning apparatus) to attract a driver's attention by alarm or by tightening up the seatbelt.

Here, such a collision damage reduction braking device and a collision warning device are collectively called a “collision damage reducing apparatus”.

Specific examples of a collision damage reducing apparatus are disclosed in Patent References 1 and 2 below.

Patent Reference 1 discloses a technique to avoid erroneous operations by retarding the activation timings of brake means (14), a warning unit (13) and other functional units while the vehicle is moving under predetermined conditions.

Patent Reference 2 estimates the forthcoming course of the vehicle incorporating the collision damage reducing apparatus and judges the possibility of a collision of the vehicle with an obstacle on the basis of the positional relationship between the estimated course and an obstacle in order to avoid misjudgment on the contact possibility with the obstacle.

[Patent Reference 1] Japanese Patent Application Laid-Open (KOKAI) No. 2007-137126

[Patent Reference 2] Japanese Patent Application Laid-Open (KOKAI) No. 2004-38245

### SUMMARY OF THE INVENTION

Techniques of both Patent References 1 and 2 have a common object to avoid inessential operations of the warning unit and a braking unit by the driver.

However, the technical concepts of Patent Reference 1 and 2 cannot attain the above object in some cases. For example, when the vehicle in question is moving on a straight road which has a curve ahead with a pole positioned at the side, it is difficult for the techniques of the Patent References to exclude the pole from objects requiring a warning or automatic braking by means of operation delay due to driving operations or a collision possibility judgment based on an estimated course of the vehicle.

If the collision damage reducing apparatus is actuated when the driver does not require the aid of the apparatus, the driver may be annoyed and confused resulting in unstable behavior of the vehicle.

With the foregoing problems in view, the object of the present invention is to provide a monitoring target detecting apparatus associated with a collision damage reducing apparatus enabled to prevent the driver from being confused, thereby avoiding unstable behavior of the vehicle, under various road traffic conditions.

To attain the above object, there is provided a collision damage reducing apparatus, which is for lessening damage of a vehicle due to a collision, monitoring an obstacle in a moving direction of a vehicle and activating a piece of equipment of the vehicle according to a possibility of a collision with the monitored object, the collision damage reducing apparatus including: designated obstacle detecting means, which is included in the vehicle, detecting an object being positioned in the moving direction and having a possibility of a collision with the vehicle to be a designated obstacle; detecting period calculating means obtaining a continuous detecting period, for which the object has been uninterruptedly detected as the designated obstacle; monitoring target acknowledging means, according to the continuous detecting period obtained by the detecting period calculating means, deciding whether or not the designated obstacle is regarded as a monitoring target that is to be monitored by the damage reducing apparatus, and deciding whether or not the designated obstacle is regarded as an activation cause to activate the equipment activated under control by the damage reducing apparatus; reliability determining means judging a possibility of the collision of the vehicle with the designated obstacle if the continuous detecting period is longer than a detecting period threshold value, and defining a reliability level coefficient indicating a degree of reliability of the designated obstacle if a result of the judging of the collision is positive; attentiveness determining means defining attentiveness coefficient, which indicates a degree of attentiveness of the driver of the vehicle and is decreased according to deterioration in the attentiveness of the driver; and detecting period threshold value adjusting means decreasing the detecting period threshold value according to decrease in the attentiveness coefficient defined by the attentiveness determining means.

This configuration can prevent behavior of the vehicle from being unstable under various driving and road states.

As a preferable feature, the collision damage reducing apparatus may further include a response time map defining a relationship between the attentiveness coefficient and a response time of the driver which increases according to decreasing in the attentiveness coefficient; and response time estimating means estimating the response time by applying the attentiveness coefficient defined by the attentiveness determining means to the response time map.

With the respond time map which defines that decrease in the attentiveness coefficient increases the respond time of the driver, it is possible to rapidly estimate an accurate respond time.

As another preferable feature, the collision damage reducing apparatus may further include: time-to-collision estimating means estimating time to collision of the vehicle with the designated obstacle; operation controlling means actuating the equipment if the time to collision estimated by the time-to-collide estimating means is equal to or smaller than a collision threshold value; and collision threshold value adjusting means increasing the collision threshold value according to increase in the response time estimated by the estimating response time means.

Accordingly, elongation of the respond time of the driver activates the equipment at earlier timing than usual.

As an additional preferable feature, the collision damage reducing apparatus may further include: a warning unit warning a driver of the vehicle, and an automatic brake control unit controlling for braking of the vehicle irrespective of the driver's intention, wherein, the detecting period threshold value is defined as a first detecting period threshold value and a second detecting period threshold value, which is bigger than the first detecting period threshold value, the monitoring target acknowledging means, if the continuous detecting period is longer than the second detecting period threshold value, decides the designated obstacle to be regarded as the activation cause to activate the warning unit and the automatic brake control unit, if the continuous detecting period is shorter than the first detecting period threshold value, decides the designated obstacle not to be regarded as the activation cause to activate the warning unit and the automatic brake control unit, and if the continuous detecting period is equal to or longer than the first detecting period threshold value and is equal to or shorter than the second detecting period threshold value, decides the designated obstacle to be regarded as the activation cause to activate the warning unit and decides the designated obstacle not to be regarded as the activation cause to activate the automatic brake control unit.

Thereby, whether or not each obstacle is determined to be an activation cause of the warning unit and the automatic brake control unit which are serving as the equipment is controlled in accordance with the continuous detecting time period of the obstacle, so that it is possible to activate these units in proper occasions.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram schematically illustrating the entire configuration of a collision damage reducing apparatus according to a first embodiment of the present invention;

FIG. 2 is a graph schematically showing a reliability level of a monitoring target determined by the monitoring target detecting apparatus of the collision damage reducing apparatus of FIG. 1;

FIG. 3 is a graph schematically showing a TTC map before an adjustment which map is used in the collision damage reducing apparatus of FIG. 1;

FIG. 4 is a graph schematically showing a TTC map after an adjustment which map is used in the collision damage reducing apparatus of FIG. 1;

FIG. 5 is a graph schematically showing a response time map used in the collision damage reducing apparatus of FIG. 1;

FIGS. 6 and 7 are flowcharts showing a succession of procedural steps of a main routine of the operation performed in the collision damage reducing apparatus of FIG. 1;

FIG. 8 is a flowchart showing a succession of procedural steps of a sub-routine of the operation performed when the reliability level is 0 in the collision damage reducing apparatus of FIG. 1;

FIG. 9 is a flowchart showing a succession of procedural steps of a sub-routine of the operation performed when the reliability level is 1 in the collision damage reducing apparatus of FIG. 1;

FIG. 10 is a flowchart showing a succession of procedural steps of a sub-routine of the operation performed when the reliability level is 2 in the collision damage reducing apparatus of FIG. 1;

FIG. 11 is a flowchart showing a succession of procedural steps of a sub-routine of the operation performed when the reliability level is 3 in the collision damage reducing apparatus of FIG. 1;

FIG. 12 is a diagram schematically showing running of a vehicle equipped with the collision damage reducing apparatus of FIG. 1; and

FIG. 13 is a graph showing an accuracy of detection by the collision damage reducing apparatus of FIG. 1.

### DESCRIPTION OF THE PREFERRED EMBODIMENT

Hereinafter, an embodiment of a collision damage reducing apparatus of the present invention will now be described with reference to the accompanying drawings.

### (a) First Embodiment

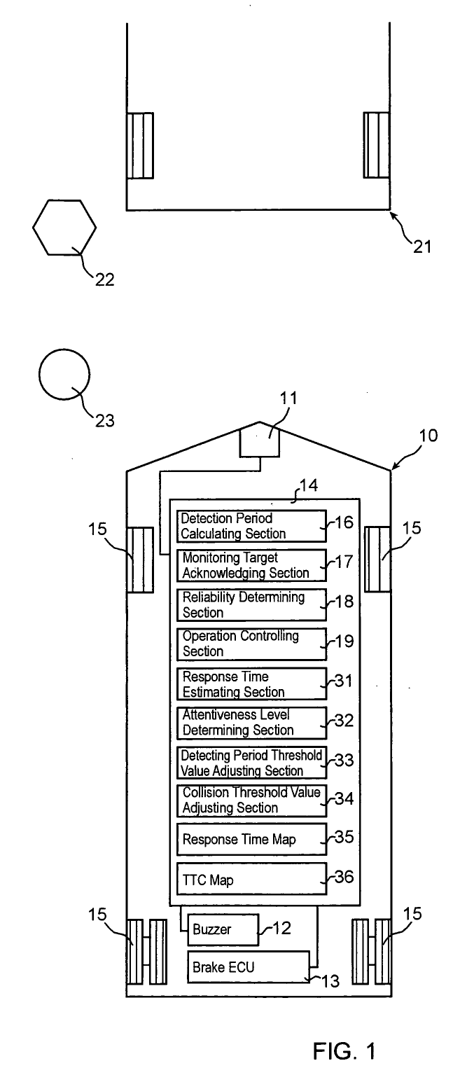

As shown in FIG. 1, vehicle 10 includes as the main parts millimeter wave radar unit (designated obstacle detecting means) 11, buzzer 12, brake ECU 13, and damage reduction ECU 14.

Millimeter wave radar unit 11 is positioned in proximity to the front end of vehicle 10, and emits a millimeter radio wave and receives radio waves reflected by an object ahead of vehicle 10, so that the object is detected to be an obstacle (designated obstacle). Millimeter wave radar unit 11 is coupled to damage reduction ECU 14 to be detailed below via a communication cable (not shown) conforming to the CAN. (Controller Area Network) standard.

Millimeter wave radar unit 11 is able to simultaneously detect a number of obstacles.

Further, millimeter wave radar unit 11 includes a radar ECU, which does not appear in the drawings.

The radar ECU calculates the relative distance L_{R} between vehicle 10 and an obstacle, and the relative velocity V_{R} between vehicle 10 and the obstacle on the basis of the received radio wave. The radar ECU further determines whether a detected obstacle is moving or not, immobile or not, or moving but about to halt or not, and outputs the result of the determination to damage reduction ECU 14.

Buzzer 12 is a warning unit positioned inside (not shown) vehicle 10, and arouses the driver's attention of vehicle 10 by making an alarm sound. Buzzer 12 is coupled to damage reduction ECU 14 via a harness and is made functional by electricity supplied from damage reduction ECU 14.

Brake ECU (automatic brake unit; equipment) 13 is an electronic control unit that controls brake devices (not shown) provided one for each of wheels 15 of vehicle 10. Brake ECU 13 is coupled to damage reduction ECU 14 via a communication cable conforming to the CAN standard and thereby functions under control of damage reduction ECU 14.

Vehicle 10 also includes a steering angle sensor (not shown) that detects a turning angle (i.e., a steering angle) θ_{SW} of the steering wheel (not shown) operated by the driver. The result of detection by the steering angle sensor is read by damage reduction ECU 14.

Damage reduction ECU 14 is an electronic control unit including a CPU, a memory, an interface unit and other elements, which do not however appear in the drawings. Damage reduction ECU 14 further includes detection period calculating section (detecting period calculating means) 16, monitoring target acknowledging section (monitoring target acknowledging means) 17, reliability determining section (reliability determining means) 18, and operation controlling section (time-to-collision estimating means, operation controlling means) 19, which are realized by means of software.

Further, damage reduction ECU 14 includes response time estimating section (response time estimating means) 31, attentiveness level determining section (attentiveness determining means) 32, detecting period threshold value adjusting section (detecting period threshold value adjusting means) 33, and collision threshold value adjusting section (collision threshold value adjusting means) 34, all of which are realized by means of software.

The memory in damage reduction ECU 14 stores response time map 35 and TTC map 36.

Among these functional sections, detection period calculating section 16 calculates a continuous detecting period ΣT_{D} for which an obstacle has continuously been detected by millimeter wave radar unit 11.

Reliability determining section 18 determines a reliability level coefficient (a degree of reliability, reliability coefficient) R of a monitoring target according to a continuous detecting period ΣT_{D} calculated by detection period calculating section 16.

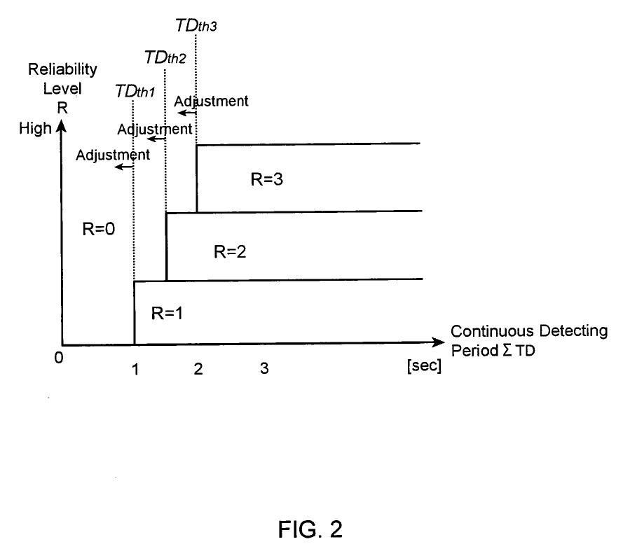

Specifically, as shown in FIG. 2, if a continuous detecting period ΣT_{D} (of a monitoring target) is in excess of the first detecting period threshold value T_{Dth1}, but is equal to the second detecting period threshold value T_{Dth2} (e.g., T₂=1.5 seconds) or shorter (i.e., T_{Dth1}<ΣT_{D}<T_{Dth2}), reliability determining section 18 determines the reliability of the monitoring target to be “relatively low” and sets the reliability level coefficient R to be 1.

In addition, if a continuous detecting period ETD (of a monitoring target) is longer than the second detecting period threshold value T_{Dth2} but is equal to a third detecting period threshold value T_{Dth3} or shorter (i.e., T_{Dth2}<ΣT_{D}≦T_{Dth3}), reliability determining section 18 determines the reliability of the monitoring target to be “relatively high” and sets the reliability level coefficient R to be 2.

Further, if a continuous detecting period ΣT_{D} (of a monitoring target) is longer than the third detecting period threshold value T_{Dth3} (i.e., T_{Dth3}<ΣT_{D}), reliability determining section 18 determines the reliability of the monitoring target to be “extremely high” and sets the reliability level coefficient R to be 3.

The first detecting period threshold value T_{Dth1}, the second detecting period threshold value T_{Dth2}, and the third detecting period threshold value T_{Dth3} are adjusted by detecting period threshold value adjusting section 33 that is detailed below. For the standard values when the attentiveness of the driver of vehicle 10 does not lower (i.e., in a normal state), the first detecting period threshold value T_{Dth1}, the second detecting period threshold value T_{Dth2}, and the third detecting period threshold value T_{Dth3} are set to be 1 second, 1.5 seconds, and 2 seconds, respectively.

Monitoring target acknowledging section 17 sets an obstacle detected by millimeter wave radar unit 11 to be a monitoring target of operation controlling section (collision damage reducing apparatus) 19 that is to be detailed below in consideration of a reliability level coefficient R determined by reliability level determining section 18, and concurrently judges whether or not the obstacle should be set to be an activation cause to activate buzzer (equipment) 12 and/or brake ECU (equipment) 13.

More specifically, if a reliability level coefficient R determined by reliability determining section 18 is equal to 0 or smaller (R≦0), monitoring target acknowledging section 17 determines the obstacle not to be an activation cause which activates both buzzer 12 and an object which activates brake ECU 13.

If the reliability level coefficient R is in excess of 0 and is equal to 1 or smaller (0<R≦1), monitoring target acknowledging section 17 determines the obstacle to be an activation cause to activate buzzer 12 but does not determine the same obstacle to be an activation cause to activate brake ECU 13.

Further, if reliability level coefficient R is bigger than 1 and is equal to 2 or smaller (1<R≦2), monitoring target acknowledging section 17 determines the obstacle to be an activation cause to activate buzzer 12 and to be an activation cause to activate brake ECU 13 in warning the driver.

Still further, if reliability level coefficient R is bigger than 2 (R>2), monitoring target acknowledging section 17 determines the obstacle to be an activation cause to activate buzzer 12 and to be an activation cause to activate brake ECU 13 in braking vehicle 10.

Consequently, requirement of a higher reliability level for an operation that has more impact on the moving of vehicle 10 can further effectively avoid erroneous detection of an obstacle and can further effectively prevent buzzer 12 and brake ECU 13 from incorrectly warning the driver and incorrectly braking vehicle 10.

Here, warning braking prompts vehicle 10 to decelerate at 0.3G (i.e., accelerates at approximately −0.3G), and emergency braking prompts vehicle 10 to decelerate at 0.6 G (i.e., accelerates at approximately −0.6 G).

Operation controlling section 19 estimates an emergency level (a collision avoidance emergency level) to take action to avoid a collision of vehicle 10 with an obstacle or, in the event of a collision of vehicle 10 with an obstacle, an emergency level (a damage reduction emergency level) to take action to reduce damage caused from the collision considering the relative distance L_{R} between the obstacle and vehicle 10 and the relative velocity V_{R} between the obstacle and vehicle 10 which have been obtained by millimeter wave radar unit 11.

The collision avoidance emergency level and the damage reduction emergency level are collectively called a countermeasure emergency level.

Operation controlling section 19 attracts the driver's attention and activates the brake unit according to the countermeasure emergency level.

More specifically, operation controlling section 19 estimates a time-to-collision TTC on the basis of the relative distance L_{R} and the relative velocity V_{R} between the obstacle and vehicle 10 which have been obtained by millimeter wave radar unit 11, and estimates that a shorter time-to-collision TTC is higher in countermeasure emergency level.

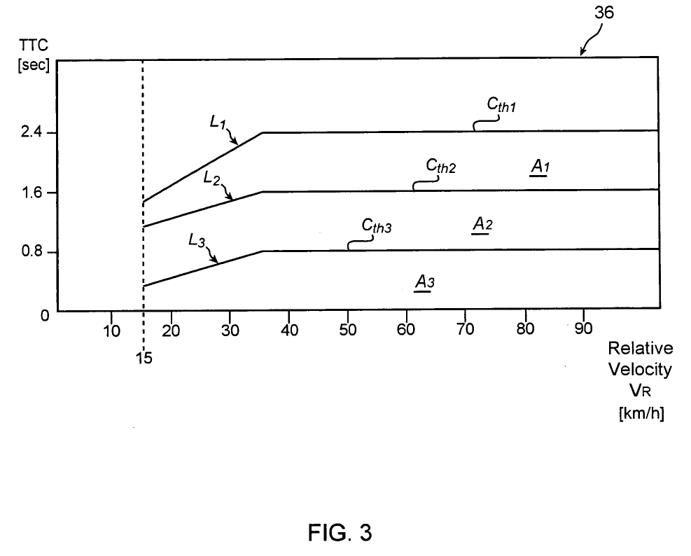

In other words, operation controlling section 19 judges which state vehicle 10 is in among first collision judgment region A1, second collision judgment region A2, and third collision judgment region A3 on TTC map 36 shown in FIG. 3, and carries out damage reducing control based on the result of the judgment.

TTC map 36 has the ordinate and the abscissa representing the time-to-collision TTC and the relative velocity V_{R}, respectively. TTC map 36 further defines a first collision threshold line (collision threshold value) Cₜₕ₁, a second collision threshold line (collision threshold value) Cₜₕ₂, and a third first collision threshold line (collision threshold value) Cₜₕ₃.

TTC map 36 further defines: the first collision judgment region A1 between the first collision line Cₜₕ₁ and the second collision line Cₜₕ₂; the second collision judgment region A2 between the second collision line Cₜₕ₂ and the third collision line Cₜₕ₃; and the third collision judgment region A3 at the third collision line Cₜₕ₃ and below.

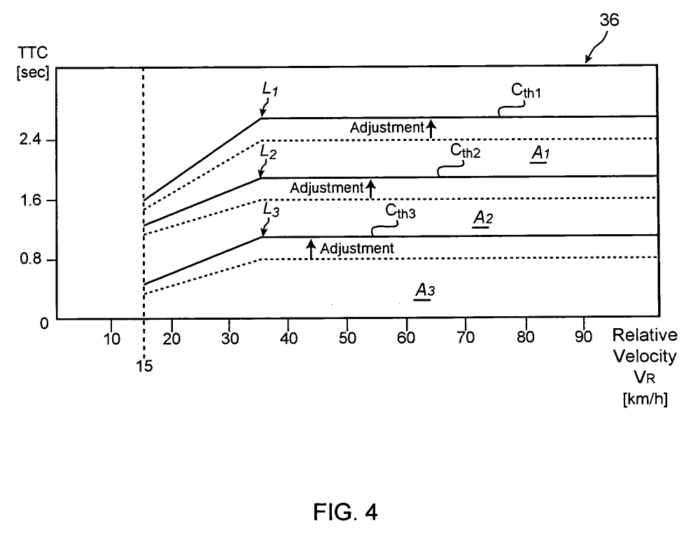

As shown in FIG. 4, the first collision threshold line Cₜₕ₁, the second collision threshold line Cₜₕ₂, and the third collision threshold line Cₜₕ₃ in TTC map 36 are sometimes adjusted by collision threshold value adjusting section 34 that is to be described below.

Even if a countermeasure emergency level is set in accordance with the time-to-collision TTC, operation controlling section 19 modifies the countermeasures of damage reducing control, depending on the reliability level coefficient R determined by reliability determining section 18. The modification will be detailed hereinafter.

If reliability determining section 18 sets the reliability level coefficient R to be “0”, operation controlling section 19 does not carry out damage reducing control, irrespective of the largeness of the time-to-collision TTC. In other words, even if the state of vehicle 10 belongs to any of the first collision judgment region A1, the second collision judgment region A2, and the third collision judgment region A3, operation controlling section 19 does not cause buzzer 12 to ring nor cause brake ECU 13 to carry out warning braking and emergency braking.

If reliability determining section 18 sets the reliability level coefficient R to be “1”, operation controlling section 19 controls only on-off of ring buzzer 12, depending on the largeness of the time-to-collision TTC. In other words, as long as the state of vehicle 10 belongs to one of the first collision judgment region A1, the second collision judgment region A2, and the third collision judgment region A3, operation controlling section 19 causes buzzer 12 to ring but does not cause brake ECU 13 to carry out warning braking or emergency braking.

If reliability determining section 18 sets the reliability level coefficient R to be “2”, operation controlling section 19 causes buzzer 12 to ring but does not cause brake ECU 13 to carry out warning braking and emergency braking under the state of vehicle 10 belonging to the first collision judgment region A1 of TTC map 36. In addition, if the reliability coefficient R is set to be “2” and the state of vehicle 10 belongs to the second collision judgment region A2 or the third collision judgment region A3, operation controlling section 19 causes buzzer 12 to ring and causes brake ECU 13 to carry out warning braking, but does not cause brake ECU 13 to carry out emergency braking.

If reliability determining section 18 sets the reliability level coefficient R to be “3” and the state of vehicle 10 belongs to the first collision judgment region A1 on TTC map 36, operation controlling section 19 causes buzzer 12 to ring but does not cause brake ECU 13 to carry out warning braking and emergency braking. If the reliability coefficient R is set to be “3” and the state of vehicle 10 belongs to the second collision judgment region A2 on TTC map 36, operation controlling section 19 causes buzzer 12 to ring and cause brake ECU 13 to carry out warning braking, but not to carry out emergency braking. Further, if the reliability coefficient R is set to be “3” and the state of vehicle 10 belongs to the third collision judgment region A3 on TTC map 36, operation controlling section 19 causes buzzer 12 to ring and causes brake ECU 13 to carry out warning braking and emergency braking.

Response time estimating section 31 applies an attentiveness level AL set by attentiveness level determining section 32 that is to be detailed below to response time map 35 in order to estimate the response time TR of the driver of vehicle 10. The attentiveness level AL is an index representing the degree of attentiveness of the driver.

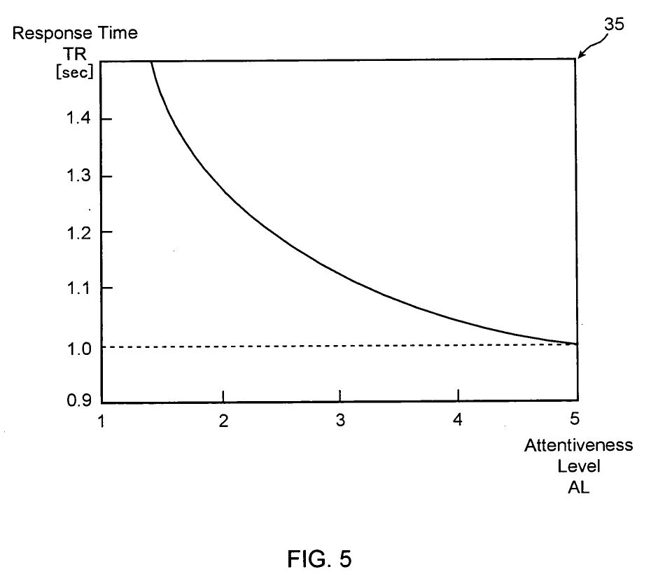

As shown in FIG. 5, response time map (time-to-response map) 35 defines the relationship between the attentiveness level AL and the response time (time to response) TR, which specifically elongates in accordance with decrease in the attentiveness level AL. Here, decrease in the attentiveness level AL means deteriorating the attentiveness of the driver. Accordingly, response time map 35 defines a relationship that the response time TR of the driver increases according to deteriorating of the attentiveness of the driver.

Attentiveness level determining section 32 determines the attentiveness level (awaking level) AL of the driver on the basis of the image obtained by a non-illustrated white-line camera, a steering angle θ_{SW} or the like detected by the steering angle sensor, and/or others. In the first embodiment, an amount of meandering of vehicle 10 is obtained simply from the steering angle θ_{SW} for a predetermined time period, and the attentiveness level AL is determined to be stepwise levels from the minimum (AL=5) to the maximum (AL=1) in accordance with the amount of meandering. Various manners of calculation of an attentiveness level AL have been already disclosed, and the description thereof is omitted here.

Detecting period threshold value adjusting section 33 increases the first detecting period threshold value T_{Dth1}, the second detecting period threshold value T_{Dth2}, and the third detecting period threshold value T_{Dth3} according to deterioration in the attentiveness level AL set by attentiveness level determining section 32, as shown by the arrows in FIG. 2.

Collision threshold value adjusting section 34 increases the first collision threshold line Cₜₕ₁, the second collision threshold line Cₜₕ₂, and the third collision threshold line Cₜₕ₃ shown in FIG. 3 in accordance with increase in the response time TR estimated by response time estimating section 31, as shown by arrows in FIG. 4.

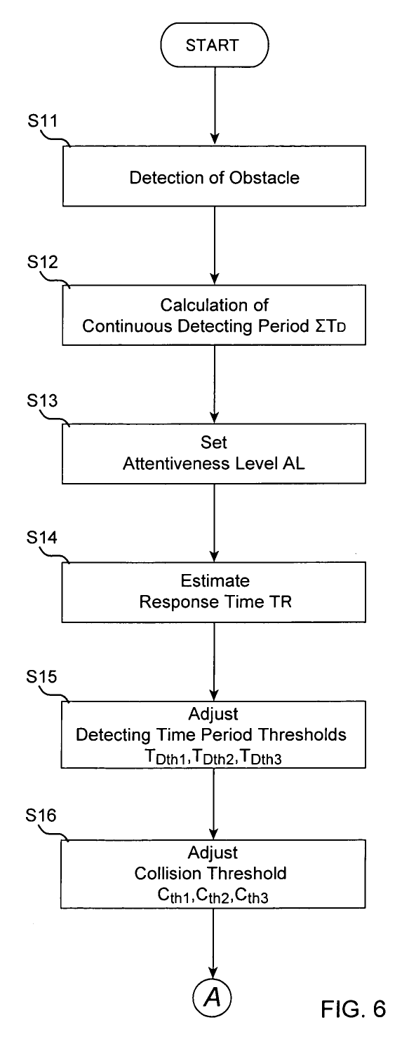

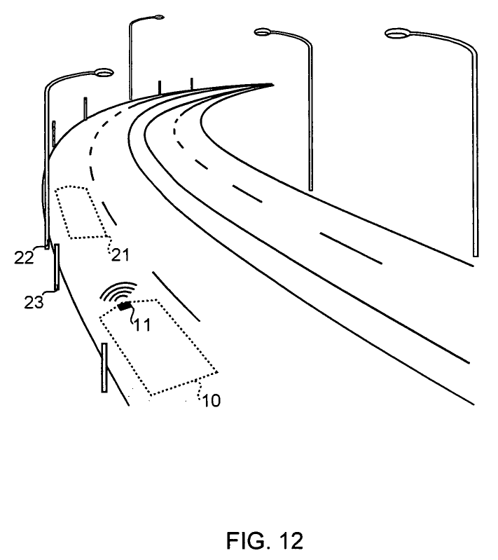

The monitoring target detecting apparatus included in with the collision damage reducing apparatus according to the first embodiment of the present invention has the configuration detailed above and therefore attains the following effects and advantages. Here, the detailed description is made along the flowcharts in FIGS. 6-11 with reference to FIGS. 1 and 12 which depict an example of a running state of vehicle 10.

As shown in FIG. 3, millimeter wave radar unit 11 mounted on vehicle 10 is activated to detect an obstacle (step S11 of FIG. 6).

In other words, preceding vehicle 21 running ahead of vehicle 10, and utility poles 22 and 23 that are on the road side are detected to be obstacles by millimeter wave radar unit 11, as shown in FIGS. 1 and 12.

The description assumes here that millimeter wave radar unit 11 detects preceding vehicle 21 running ahead of vehicle 10, utility pole 22 and pole 23 at the side of the lane as obstacles.

After that, detection period calculating section 16 calculates a time length, for which each of preceding vehicle 21, utility pole 22, and pole 23 has been continuously detected to be an obstacle by millimeter wave radar unit 11, that is, for a continuous detecting period ΣT_{D} (step S12).

Attentiveness level determining section 32 determines the attentiveness level AL of the driver of vehicle 10 on the basis of the steering angle θ_{SW} detected by the steering angle sensor (step S13).

Then response time estimating section 31 applies the attentiveness level AL set in step S13 to response time map 35 shown in FIG. 5 to estimate the respond time TR of the driver of vehicle 10 (step S14). Therefore, if the attentiveness level AL is relatively low and the attentiveness of the driver is considered to be deteriorating, the response time TR is estimated to be relatively long. On the other hand, if the attentiveness level AL of the driver of vehicle 10 is relatively high and the attentiveness of the driver is considered not to be deteriorating, the response time TR is estimated to be relatively short.

In accordance with decrease in the attentiveness level AL set in S13, detecting period threshold value adjusting section 33 decreases first detecting period threshold value T_{Dth1}, the second detecting period threshold value T_{Dth2}, and the third detecting period threshold value T_{Dth3}, as shown in FIG. 2 (step S15).

In accordance with elongation of the respond time TR estimated in said step S13, collision threshold value adjusting section 34 increases, as shown in FIG. 4, the first collision threshold line Cₜₕ₁, the second collision threshold line Cₜₕ₂, and the third collision threshold line Cₜₕ₃ shown in FIG. 3 (step S16).

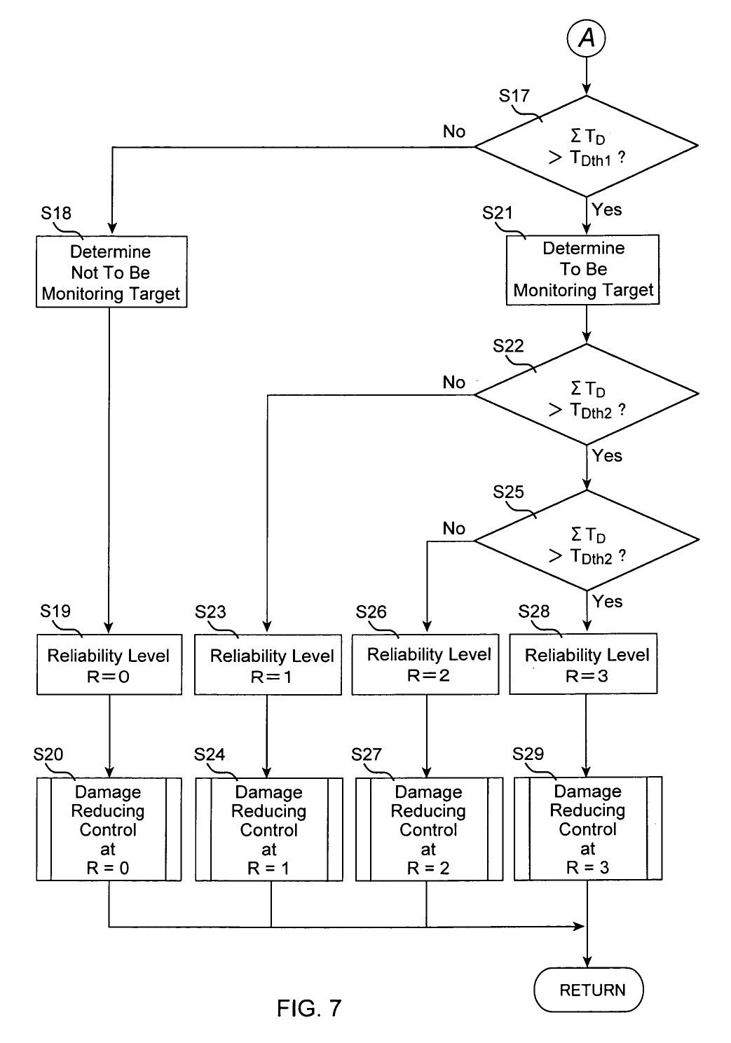

Then, monitoring target acknowledging section 17 judges whether or not the continuous detecting period ΣT_{D} calculated for each obstacle by detection period calculating section 16 is equal to or shorter than the first detection period threshold value T_{Dth1} (=1 second) (step S17 of FIG. 7).

If the continuous detecting period ΣT_{D} is equal to or shorter than the first detecting period threshold value T_{Dth1} (No route in step S17), monitoring target acknowledging section 17 concludes that the obstacle need not be determined to be a monitoring target (step S18) and reliability determining section 18 sets the reliability level coefficient R to be “0” (step S19).

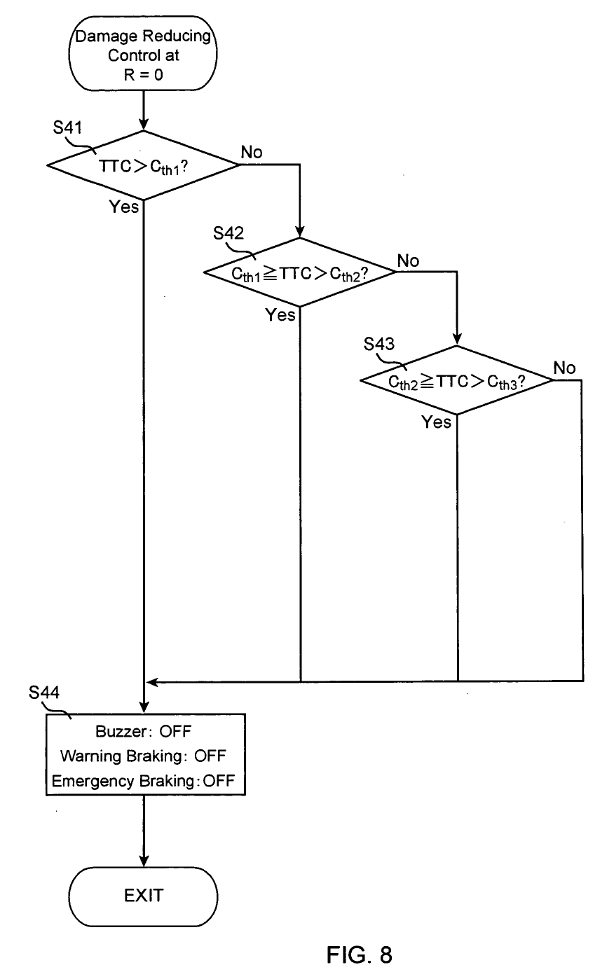

After that, a sub-routine for damage reduction control associated with the reliability level R “0” is carried out (step S20). In this case, operation controlling section 19 does not carry out damage reducing control irrespective of the largeness of time-to-collision TTC as shown in FIG. 8. More specifically, operation controlling section 19 does not ring buzzer 12, nor carry out warning braking or emergency braking with brake ECU 13 (step S44) irrespective of whether or not the time-to-collision TTC is in excess of the first collision threshold line Cₜₕ₁ defined on TTC map 36 (step S41); irrespective of whether or not the time-to-collision TTC is the first collision threshold line Cₜₕ₁ or less and is in excess of the second collision threshold line Cₜₕ₂ (step S42); and irrespective of whether or not the time-to-collision TTC is the second collision threshold line Cₜₕ₂ or less and is in excess of the third collision threshold line Cₜₕ₃ (step S43), as shown in FIG. 8.

Conversely, if the continuous detecting period ΣT_{D} is in excess of T_{Dth1} (Yes route in step S17 of FIG. 7), monitoring target acknowledging section 17 concludes that the obstacle needs to be regarded as a monitoring target and operation controlling section 19 therefore determines the obstacle to be a monitoring target (step S15).

Then reliability determining section 18 judges whether or not the continuous detecting period ΣT_{D} is in excess of the second detecting period threshold value T_{Dth2} (=1.5 seconds) (step S22). Here, if the continuous detecting period ΣT_{D} is equal to or shorter than the second detecting period threshold value T_{Dth2} (No route in step S22), reliability determining section 18 concludes that the degree of the reliability of the monitoring object is relatively low and sets the reliability level coefficient R to be “1” (step S23).

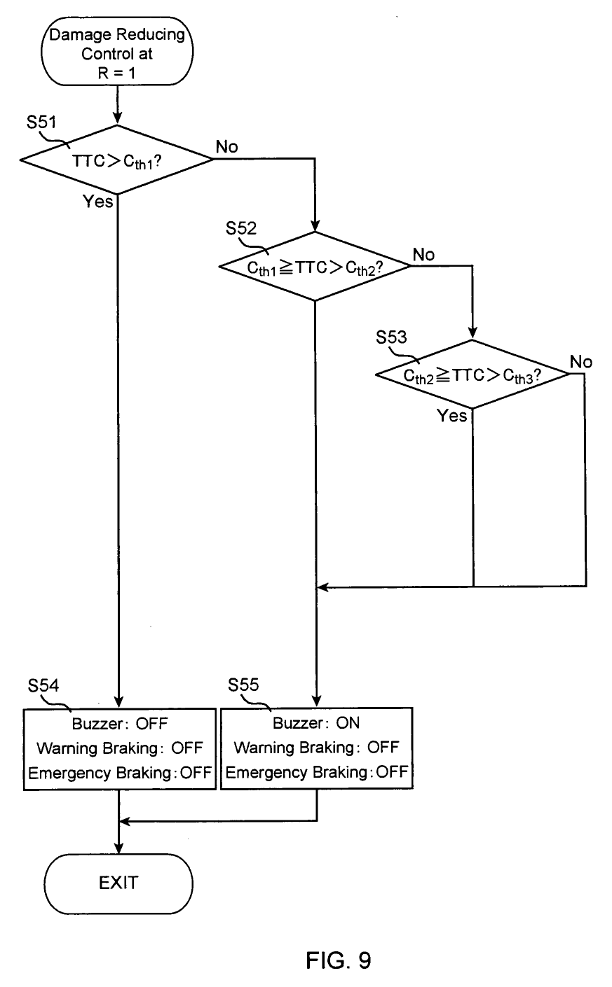

After that, a sub-routine for damage reduction control associated with the reliability level coefficient R “1” is carried out (step S24). In this case, operation controlling section 19 controls only on and off of buzzer 12 in accordance with the largeness of the time-to-collision TTC, as shown in FIG. 9.

More specifically, if the time-to-collision TTC is in excess of the first collision threshold line Cₜₕ₁ defined on TTC map 36 (Yes route step S51), operation controlling section 19 does not ring buzzer 12, nor carry out warning braking or emergency braking with brake ECU 13 (step S54).

Conversely, if the time-to-collision TTC is the first collision threshold line Cₜₕ₁ or less (Yes route in step S52), operation controlling section 19 rings buzzer 12, but does not carry out warning braking nor emergency braking with brake ECU 13 (step S55) irrespective of whether or not the time-to-collision TTC is the second collision threshold line Cₜₕ₂ or less and is in excess of the third collision threshold line Cₜₕ₃ (step S53).

If the continuous detecting period ΣT_{D} is longer than the second detecting period threshold T_{Dth2} (Yes route in step S22 of FIG. 7), reliability determining section 18 judges whether or not the continuous detecting period ΣT_{D} is in excess of the third detecting period threshold value T_{Dth3} (=2 seconds) (step S25).

If the continuous detecting period ΣT_{D} is equal to or shorter than the third detecting period threshold T_{Dth3} ((No route in step S25), reliability determining section 18 concludes that the degree of reliability of the monitoring object acknowledged by monitoring target acknowledging section 17 is relatively high and sets the reliability level coefficient R to be “2” (step S26).

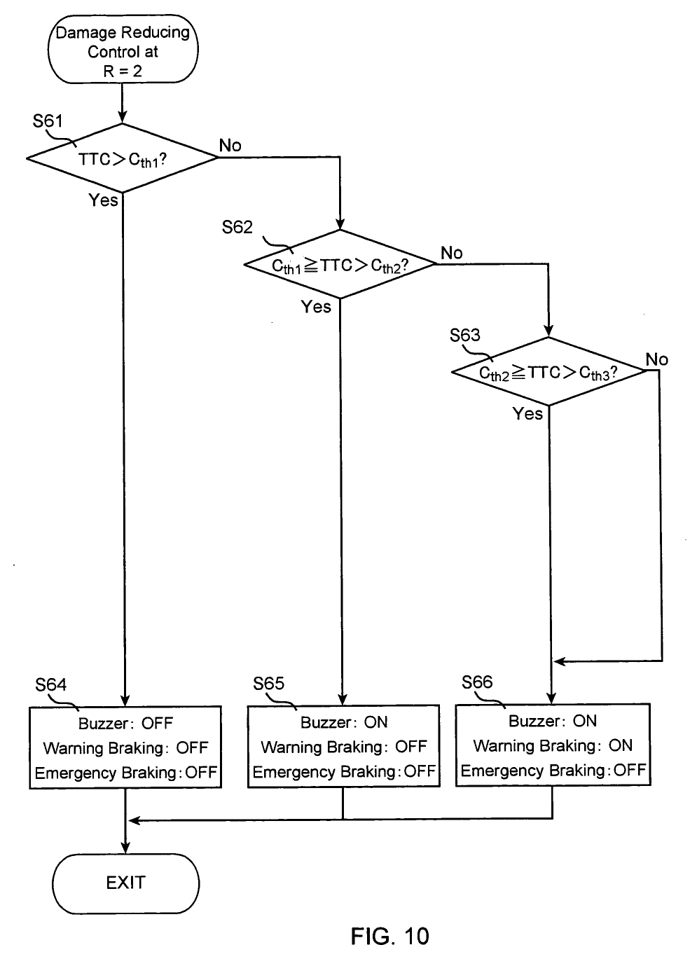

After that, a sub-routine for damage reduction control associated with the reliability level coefficient R “2” is carried out (step S27). More specifically, if the time-to-collision TTC is in excess of the first collision threshold line Cₜₕ₁ as shown in FIG. 10 (Yes route in step S61), operation controlling section 19 does not ring buzzer 12, nor carry out warning braking or emergency braking with brake ECU 13 (step S64).

If the time-to-collision TTC is the first collision threshold line Cₜₕ₁ or less and is in excess of the second collision threshold line Cₜₕ₂ (Yes route in step S62), operation controlling section 19 rings buzzer 12, but does not carry out warning braking nor emergency braking with brake ECU 13 (step S66).

Further, if the time-to-collision TTC is the second collision threshold line Cₜₕ₂ or less, operation controlling section 19 rings buzzer 12 and simultaneously carries out warning braking with brake ECU 13, but does not carry out emergency control (step S66) irrespective of whether or not the time-to-collision TTC is in excess of the third collision threshold line Cₜₕ₃ (Yes route and No route in step S63).

If the continuous detecting period ΣT_{D} is judged to be in excess of the third collision threshold value T_{Dth3} (Yes route in step S25), reliability determining section 18 concludes that the degree of reliability of the monitoring object acknowledged by monitoring target acknowledging section 17 is extremely high and sets the reliability level coefficient R to be “3” (step S28).

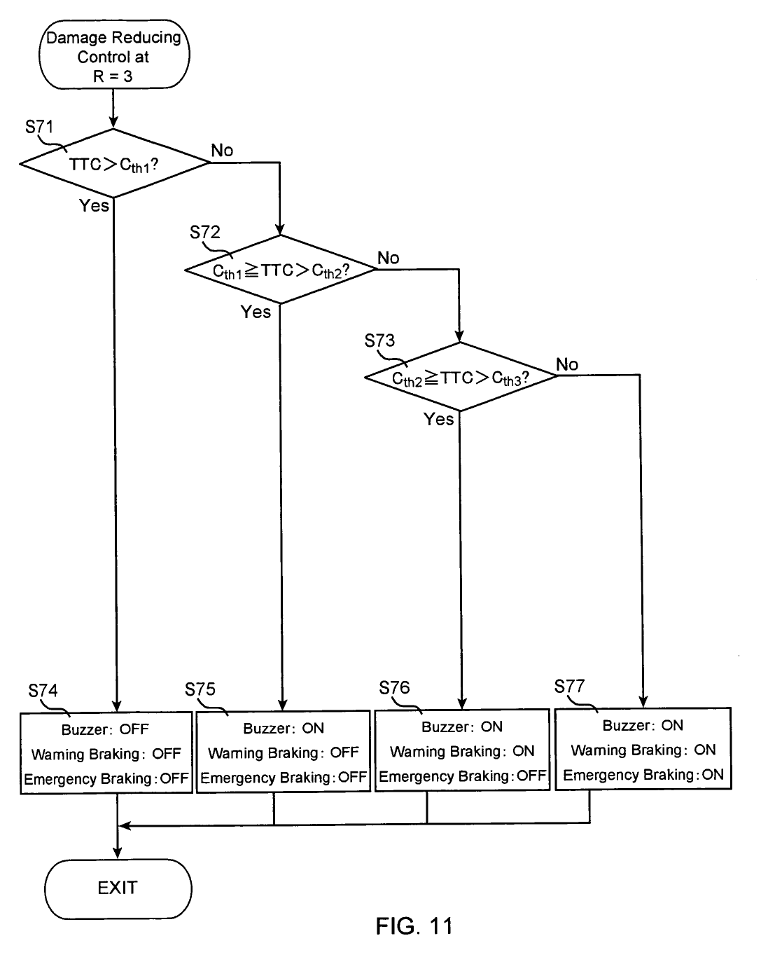

After that, a sub-routine for damage reduction control associated with the reliability level coefficient R “3” is carried out (step S29). More specifically, if the time-to-collision TTC is in excess of the first collision threshold line Cₜₕ₁ (Yes route in step S71), operation controlling section 19 does not ring buzzer 12, nor carry out warning braking or emergency braking with brake ECU 13 (step S74), as shown in FIG. 11.

Further, if the time-to-collision TTC is the first collision threshold line Cₜₕ₁ or less and in excess of the second collision threshold line Cₜₕ₂ (Yes route in step S72), operation controlling section 19 rings buzzer 12, but does not carry out warning braking nor emergency braking with brake ECU 13 (step S75).

If the time-to-collision TTC is the second collision threshold line Cₜₕ₂ or less and is in excess of the third collision threshold line Cₜₕ₃ (Yes route in step S73) operation controlling section 19 rings buzzer 12 and carries out warning braking with brake ECU 13, but does not carry out emergency braking (step S76).

Then if the time-to-collision TTC comes to be equal to or less than the third collision threshold line Cₜₕ₃ (Yes route in step S74), operation controlling section 19 rings buzzer 12 and carries out both warning braking and emergency braking with brake ECU 13 (step S77).

Explanation will be made with reference to the example shown in FIGS. 1 and 12, assuming that moving vehicle 10 passes by the side of utility poles 22 and 23 in a moment and that a time period (continuous detecting period ΣT_{D}) for which millimeter wave radar unit 11 has continuously detected the utility poles 22 and 23 to be obstacles is very short (e.g., 0.7 seconds) (steps S11 and S12).

At that time, attentiveness level determining section 32 varies the attentiveness level AL from “5” to “3” in accordance with deterioration in attentiveness of the driver (step S13).

In this case, response time estimating section 31 estimates that the response time TR when the attentiveness level AL is “3” is 1.13 seconds (see FIG. 5, step S14).

Detecting period threshold value adjusting section 33 adjusts the first detecting period threshold value T_{Dth1}, the second detecting period threshold value T_{Dth2}, and the third detecting period threshold value T_{Dth3} by subtracting the difference (a variation amount of the response time TR_{def}=0.13 seconds) between the respond time TR (i.e., the standard response time TR₀=1.0 second) when the attentiveness level AL is “5” and that (1.13 seconds) when the attentiveness level is “3” from each of the threshold values. As a consequence, the first detecting period threshold T_{Dth1} is adjusted from 1 second to 0.87 seconds (see FIG. 2, step S15).

In other words, since the continuous detecting period ΣT_{D} (=0.7 seconds) of each of utility poles 22 and 23 is shorter than the adjusted first detecting period threshold value T_{Dth1} (=0.87 seconds), utility poles 22 and 23 are not determined to be the monitoring objects of operation controlling section 19 (No route in step S17 and step S18). The continuous detecting period ΣT_{D} (=0.7 seconds) of each of utility pole 22 and pole 23 is also equal to or shorter than the original first detecting period threshold value T_{Dth1} (=1 second). For this reason, even if the attentiveness level AL drops from “5” to “3” or even if the attentiveness level AL remains “5”, the presence of utility pole 22 and pole 23 does not cause buzzer 12 to make sound nor cause brake ECU 13 to carry out warning braking or emergency braking (step S44).

In the meanwhile, it is assumed that millimeter wave radar unit 11 has continuously detected preceding vehicle 21 to be an obstacle for a relatively long time period (e.g., 1.4 seconds) (steps S11 and S12).

At that time, similarly to the case where utility poles 22 and 23 are detected, the attentiveness level AL is varied from “5” to “3” (step S13) and the response time TR is estimated to be 1.13 seconds (step S14).

Detecting period threshold value adjusting section 33 adjusts the first detecting period threshold value T_{Dth1}, the second detecting period threshold value T_{Dth2}, and the third detecting period threshold value T_{Dth3} by subtracting the variation amount of the response time TR_{def} (=0.13 seconds) from each of these threshold values. As a consequence, the second detecting period threshold T_{Dth2} is adjusted from 1.5 seconds to 1.37 seconds (step S15).

Further in this case, collision threshold value adjusting section 34 increases the maximum value (i.e., 2.4 seconds) of the first collision threshold line Cₜₕ₁, the maximum value (i.e., 1.6 seconds) of the second collision threshold line Cₜₕ₂, the maximum value (i.e., 0.8 seconds) of the third collision threshold line Cₜₕ₃ by the variation amount of the response time TR_{def} (=0.13 seconds). In other words, the maximum values 2.4 seconds, 1.6 seconds, and 0.8 seconds of the first, second, and third collision threshold lines Cₜₕ₁, Cₜₕ₂, and Cₜₕ₃ are adjusted to 2.53 seconds, 1.73 seconds, and 0.93 seconds, respectively (step S16).

The continuous detecting period ΣT_{D} of preceding vehicle 21 is 1.4 seconds, which is longer than the adjusted first detection period threshold value T_{Dth1} (=0.87 seconds) (Yes route in step S17) and also longer than the second detecting period threshold value T_{Dth2} (=1.37 seconds) but is shorter than the adjusted third detecting period threshold value T_{Dth3} (=1.87 seconds) (No route in step S25).

Accordingly, reliability determining section 18 considers the reliability of preceding vehicle 21 serving as an obstacle to be relatively high and sets the reliability level coefficient R to be “2” (step S26).

Assuming that the second detecting time period T_{DTth2} is not adjusted by detecting period threshold value adjusting section 33, the reliability level of preceding vehicle 21 serving as an obstacle should have been set to be “1”, which means the second detecting period threshold value T_{Dth2} before being adjusted is 1.5 seconds. Since the continuous detecting period ΣT_{D} (=1.4 seconds) of preceding vehicle 21 is shorter than the second detecting threshold value T_{Dth2} (=1.5 seconds) before the adjustment (No route in step S22), the reliability level coefficient R of preceding vehicle 21 serving as an obstacle should have been set to be “1” (step S23).

However, since the first detecting period threshold value T_{Dth1} , the second detecting period threshold value T_{Dth2} , and the third detecting period threshold value T_{Dth3} are adjusted in accordance with deteriorating of the attentiveness of the driver, an obstacle which is originally not regarded as a monitoring object because of a relatively low reliability level is regarded as a target that requires monitoring.

Consequently, since monitoring objects are determined from a broader range of obstacles than usual for a driver with deteriorating attentiveness, warning for pole 23 and/or utility pole 22 at the shoulder of the road is issued to the driver. Such a warning annoys drivers with normal attentiveness, but is effective for the driver with deteriorating attentiveness.

If the attentiveness of the driver deteriorates, the course of vehicle 10 meanders in most cases. Also on this point, it is preferable that monitoring objects are determined from a broader range of obstacles.

Since the first detecting period threshold value T_{Dth1} , the second detecting period threshold value T_{Dth2} , and the third detecting period threshold value T_{Dth3} are adjusted in consideration of the degree of deteriorating of the driver's attentiveness, the reliability level R of an obstacle is not unreasonably increased. In other words, since damage reducing control is not based only on a time-to-collision TTC, alarm, warning braking and emergency braking are not unnecessarily carried out. That can prevent the stresses of the driver from increasing.

Further, adjustment of the first, second, and third collision threshold lines Cₜₕ₁ , Cₜₕ₂ , and Cₜₕ₃ by collision threshold value adjusting section 34 can make it possible to execute the damage reducing control at an earlier timing than usual. In other words, alarm warning, warning braking and emergency braking can be carried out at an earlier timing by the increase in the responding time TR caused by deteriorating attentiveness of the driver.

Thereby, the attentiveness of the driver is attracted to reduce the possibility of the collision of the vehicle 10 with preceding vehicle 21. Even in case of collision of vehicle 10 with preceding vehicle 21, the damage resulting from the collision can be reduced as much as possible.

Here, the first embodiment of the present invention is further compared to the techniques disclosed in above Patent References 1 and 2.

The techniques disclosed in above Patent References 1 and 2 estimate the possibility of a collision of the vehicle with an obstacle or vary the timing to activate the brake devices and a warning unit, but do not select a monitoring target of the collision damage reducing apparatus among obstacles detected by a millimeter wave radar or a laser radar.

In the above conventional techniques, calculation of collision possibilities with all the obstacles detected by a millimeter wave radar or a laser radar increases the processing load on the collision damage reducing apparatus.

Conversely, the first embodiment of the present invention determines whether or not one or more of preceding vehicle 21, utility pole 22, and pole 23 that are detected to be obstacles positioned ahead of moving vehicle 10 needs to be regarded as a monitoring target of operation controlling section (collision damage reducing apparatus) 19 with high accuracy. With this configuration, it is possible to prevent the processing load on operation controlling section 19 from increasing.

Reliability determining section 18 determines a reliability level coefficient R of a monitoring target according to the length of the continuous detecting period ΣT_{D}, and monitoring target acknowledging section 17 determines the monitoring target to be an activation cause to activate buzzer 12 and brake ECU 13 in the illustrated example. Though the processes accomplished by the functional sections 17 and 18 are relatively simple, the accuracy of the processes is considerably high. The above point will be detailed with reference to FIG. 5, which represents the collective result of experiments conducted using five test vehicles each including a millimeter wave radar unit, a drive data recorder, a motion picture camera and a motion picture recorder.

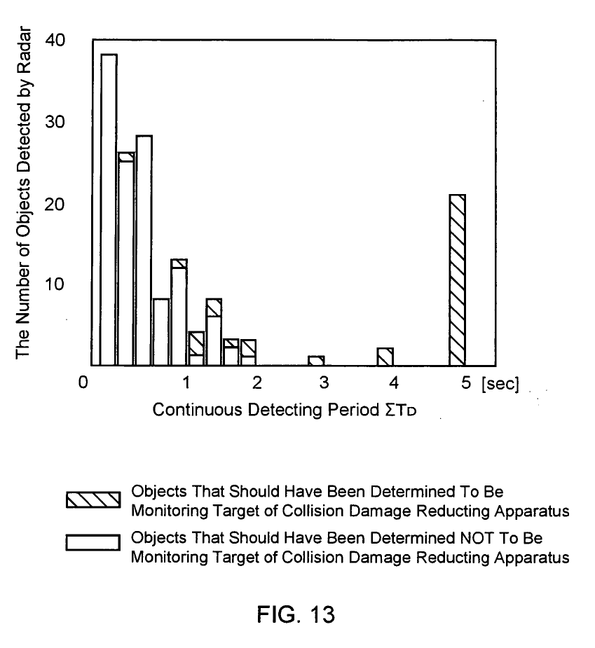

The graph in FIG. 13 shows the number of objects which the millimeter wave radar has captured to be obstacles for each range of a time period (i.e., a continuous detecting period ΣT_{D}) for which the millimeter wave radar has continuously detected an obstacle.

A hatched bar in FIG. 13 represents the number of objects which should have been determined to be monitoring targets because the objects were required for the aid of the collision damage reducing apparatus. Conversely, a white solid bar represents the number of objects which should not have been determined to be monitoring targets because the objects were not required for the aid of the function of the collision damage reducing apparatus. The requirement for the aid of the collision damage reducing apparatus is determined by Inventors' visible check of the motion picture obtained by use of motion picture cameras and/or motion picture recorders, information of moving states of the test vehicles recorded by the drive data recorders, information provided from the drivers, and others.

For example, if the warning and/or the automatic braking have been activated by the presence of a pole or a utility pole positioned outside the lane through which the vehicle was running, the requirement is determined in view of whether or not the driver has been annoyed by the activation or whether or not the warning should have actually been issued.

As shown in the graph of FIG. 13, the number of captured objects that should be regarded as monitoring targets gradually increases when the continuous detecting period ETD comes to be 1 second or longer, and all the captured objects should be determined to be monitoring targets when the continuous detecting period ΣT_{D} comes to be 4 seconds or longer.

As understood from the above result, monitoring target acknowledging section 17 and reliability determining section 18 function with considerable accuracy although the functions are quite simple.

Since determination of a reliability level of a monitoring target according to the length of the continuous detecting period ΣT_{D} by reliability determining section 18 and determination of the monitoring target to be an activation cause to activate buzzer 12 and brake ECU 13 by monitoring target acknowledging section 17 are relatively simple, damage reduction ECU 14 can avoid increase in processing load thereon.

By preventing the processing load on operation controlling section 19 from increasing, operation controlling section 19 can send proper instructions to buzzer 12 and brake ECU 13 without delay.

The above prevention makes it possible to suppress the consumption of electricity by damage reduction ECU 14 and suppress the resultant heat emitted from damage reduction ECU 14.

Variation in a reliability level of a monitoring target according to the length of the continuous detecting period ΣT_{D} of the monitoring target can improve the accuracy in operations performed by operation controlling section 19.

Further, since detecting period threshold value adjusting section 33 decreases the first detecting time period T_{Dth1} , the second detecting time period T_{Dth2} , and the third detecting time period T_{Dth3} in accordance with decrease in attentiveness level AL set by attentiveness level determining section 32, the reliability level coefficient R of each monitoring target can be set in consideration of lowering of the attentiveness of the driver.

That makes it possible to prevent the driver running the vehicle in various road states from being confused and to prevent the behavior of the vehicle from being unstable.

The use of response time map 35 can rapidly estimate an accurate respond time TR of the driver without requiring complex calculation and estimation methods.

In accordance with elongation of respond time TR, the first collision threshold line Cₜₕ₁ , the second collision threshold line Cₜₕ₂ , and the third collision threshold line Cₜₕ₃ are adjusted to increase. Thereby, the elongation of the respond time TR of the driver can be compensated by activation of buzzer 12 and brake ECU 13 at an earlier timing than usual.

As to whether or not an obstacle is set to be an activation cause of buzzer 12 and brake ECU 13 can be controlled on the basis of the reliability level R of the obstacle, warning by buzzer 12 and warning braking and emergency braking by brake ECU 13 can be appropriately carried out on proper occasions.

The first embodiment of the present invention has been detailed as above, but the present invention should by no means be limited to the foregoing embodiment. Various changes and modifications can be suggested without departing from the gist of the present invention.

For example, the first embodiment detects obstacles with millimeter wave radar unit 11, to which the present invention is not limited and which may be substituted by a laser radar (infrared radar) or a camera.

In the first embodiment, damage reduction ECU 14 is coupled to millimeter wave radar unit 11, buzzer 12, and brake ECU 13 via communication cables conforming to the CAN standard. The connection cable is however not limited to CAN-standard cables, but may alternatively be cables conforming to the LIN (Local Interconnect Network) standard, the IDB-1394 standard, or other standards.

Further, in the first embodiment, operation controlling section 19 controls buzzer 12 and brake ECU 13, but the present invention is not limited to this. Alternatively operation controlling section 19 may control the seatbelt pretensioner to warn the driver or to further surely restrain the driver.

From the invention thus described, it will be obvious that the same may be varied in many ways. Such variations are not regarded as a departure from the spirit and scope of the invention, and all such modifications as would be obvious to one skilled in the art are intended to be included within the scope of the following claims.

What is claimed is:

1. A collision damage reducing apparatus, which is for lessening damage of a vehicle due to a collision, monitoring an obstacle in a moving direction of a vehicle and activating apiece of equipment of the vehicle according to a possibility of a collision with the monitored object, said collision damage reducing apparatus comprising:
designated obstacle detecting means, which is included in said vehicle, detecting an object being positioned in the moving direction and having a possibility of a collision with the vehicle to be a designated obstacle;
detecting period calculating means obtaining a continuous detecting period, for which the object has been uninterruptedly detected as the designated obstacle;
monitoring target acknowledging means, according to the continuous detecting period obtained by said detecting period calculating means, deciding whether or not the designated obstacle is regarded as a monitoring target that is to be monitored by said damage reducing apparatus, and deciding whether or not the designated obstacle is regarded as an activation cause to activate the equipment activated under control by said damage reducing apparatus;
reliability determining means judging a possibility of the collision of the vehicle with the designated obstacle if the continuous detecting period is longer than a detecting period threshold value), and defining a reliability level coefficient indicating a degree of reliability of the designated obstacle if a result of the judging of the collision is positive;
attentiveness determining means defining attentiveness coefficient, which indicates a degree of attentiveness of the driver of the vehicle and is decreased according to deterioration in the attentiveness of the driver; and
detecting period threshold value adjusting means decreasing the detecting period threshold value according to decrease in the attentiveness coefficient defined by said attentiveness determining means.

2. The collision damage reducing apparatus according to claim 1, further comprising:
a response time map defining a relationship between the attentiveness coefficient and a response time of the driver which increases according to decreasing in the attentiveness coefficient; and
response time estimating means estimating the response time by applying the attentiveness coefficient defined by said attentiveness determining means to said response time map.

3. The collision damage reducing apparatus according to claim 2, further comprising:
time-to-collision estimating means estimating time to collision of the vehicle with the designated obstacle;
operation controlling means actuating the equipment if the time to collision estimated by said time-to-collide estimating means is equal to or shorter than a collision threshold value; and
collision threshold value adjusting means increasing the collision threshold value according to increase in the response time estimated by said estimating response time means.

4. The collision damage reducing apparatus according to claim 1, further comprising:
a warning unit warning a driver of the vehicle, and
an automatic brake control unit controlling braking of the vehicle irrespective of the driver's intention,
wherein,
the detecting period threshold value is defined as a first detecting period threshold value and a second detecting period threshold value, which is longer than the first detecting period threshold value,
said monitoring target acknowledging means,
if the continuous detecting period is longer than the second detecting period threshold value, decides the designated obstacle to be regarded as the activation cause to activate the warning unit) and the automatic brake control unit,
if the continuous detecting period is shorter than the first detecting period threshold value, decides the designated obstacle not to be regarded as the activation cause to activate the warning unit and the automatic brake control unit, and
if the continuous detecting period is equal to or longer than the first detecting period threshold value and is equal to or shorter than the second detecting period threshold value, decides the designated obstacle to be regarded as the activation cause to activate the warning unit and decides the designated obstacle not to be regarded as the activation cause to activate the automatic brake control unit.

5. The collision damage reducing apparatus according to claim 2, further comprising:
a warning unit warning a driver of the vehicle, and
an automatic brake control unit controlling for braking of the vehicle irrespective of the driver's intention,
wherein,
the detecting period threshold value is defined as a first detecting period threshold value and a second detecting period threshold value, which is longer than the first detecting period threshold value,
said monitoring target acknowledging means,
if the continuous detecting period is longer than the second detecting period threshold value, decides the designated obstacle to be regarded as the activation cause to activate the warning unit and the automatic brake control unit,
if the continuous detecting period is shorter than the first detecting period threshold value, decides the designated obstacle not to be regarded as the activation cause to activate the warning unit and the automatic brake control unit, and
if the continuous detecting period is equal to or longer than the first detecting period threshold value and is equal to or shorter than the second detecting period threshold value, decides the designated obstacle to be regarded as the activation cause to activate the warning unit and decides the designated obstacle not to be regarded as the activation cause to activate the automatic brake control unit.

6. The collision damage reducing apparatus according to claim 3, further comprising:
a warning unit warning a driver of the vehicle, and
an automatic brake control unit controlling for braking of the vehicle irrespective of the driver's intention,
wherein,
the detecting period threshold value is defined as a first detecting period threshold value and a second detecting period threshold value, which is bigger than the first detecting period threshold value,
said monitoring target acknowledging means,
if the continuous detecting period is longer than the second detecting period threshold value, decides the designated obstacle to be regarded as the activation cause to activate the warning unit and the automatic brake control unit,
if the continuous detecting period is shorter than the first detecting period threshold value, decides the designated obstacle not to be regarded as the activation cause to activate the warning unit and the automatic brake control unit, and
if the continuous detecting period is equal to or longer than the first detecting period threshold value and is equal to or shorter than the second detecting period threshold value, decides the designated obstacle to be regarded as the activation cause to activate the warning unit and decides the designated obstacle not to be regarded as the activation cause to activate the automatic brake control unit.
